(19) United States
(12) Patent Application Publication
(10) Pub. No.: US 2022/0291029 A1
(43) Pub. Date: Sep. 15, 2022

(54) FLOW SENSING DEVICE

(71) Applicant: KOA CORPORATION, Nagano (JP)

(72) Inventors: Koji UENOYAMA, Osaka (JP); Shigeo GOTOH, Osaka (JP); Yoji KOBAYASHI, Nagano (JP)

(73) Assignee: KOA CORPORATION, Nagano (JP)

(21) Appl. No.: 17/641,681

(22) PCT Filed: Sep. 11, 2020
(86) PCT No.: PCT/JP2020/034578

§ 371 Date: Mar. 9, 2022

(30) Foreign Application Priority Data
Sep. 12, 2019 (JP) 2019-166533

(51) Int. Cl. G01F 1/69; G01F 15/12; G01F 15/18

(52) U.S. Cl. CPC G01F 1/69; G01F 15/125; G01F 15/18

(57) ABSTRACT

An object is to provide a flow sensing device improved in weather resistance and insect resistance. A flow sensing device includes: a cover member; a cap member disposed below the cover member; a foreign-body intrusion prevention net surrounding a space between the cover member and the cap member; a light emitting element disposed in a housing space surrounded by the cover member, the cap member, and the foreign-body intrusion prevention net; and a sensing element disposed inside the foreign-body intrusion prevention net in the housing space, the sensing element including a thermosensitive resistive element.

### TECHNICAL FIELD

The present invention relates to a flow sensing device that detects the flow rate of fluid.

### BACKGROUND ART

There is a known flow sensing device including a thermosensitive resistor for heat generation and a thermosensitive resistor for temperature compensation that are disposed in a channel for a fluid, such as air, and being capable of detecting, on the basis of a variation in resistance value corresponding to the amount of heat radiation of the thermosensitive resistor for heat generation due to a variation in flow rate, the flow rate.

For example, the invention disclosed in Patent Literature 1 relates to a flow sensing device including a thermosensitive resistor for heat generation disposed on one side of a circuit board and a thermosensitive resistor for temperature compensation disposed on the other side.

### CITATION LIST

### Patent Literature

Patent Literature 1: JP H9-53967 A

### SUMMARY OF INVENTION

### Technical Problem

For example, in a case where a flow sensing device is used outdoors, in order to keep its detecting sensitivity favorable, improvements are required in weather resistance and insect resistance.

However, Patent Literature 1 gives no description of weather resistance and insect resistance and discloses no flow sensing device having a structure that is weatherproof and insectproof.

The present invention has been made in consideration of such an issue, and an object of the present invention is to provide a flow sensing device improved in weather resistance and insect resistance.

### Solution to Problem

A flow sensing device according to an aspect of the present invention includes: a cover member; a cap member disposed below the cover member; a foreign-body intrusion prevention net surrounding a space between the cover member and the cap member; a light emitting element disposed in a housing space surrounded by the cover member, the cap member, and the foreign-body intrusion prevention net; and a sensing element disposed inside the foreign-body intrusion prevention net in the housing space, the sensing element including a thermosensitive resistive element.

### Advantageous Effects of Invention

The structure of a flow sensing device according to the present invention enables enhancements in weather resistance and insect resistance.

### BRIEF DESCRIPTION OF DRAWINGS

FIG. 1 is a perspective view of a flow sensing device according to the present embodiment.

FIG. 2 is an exploded perspective view of the flow sensing device illustrated in FIG. 1.

FIG. 3 is a sectional view of the flow sensing device illustrated in FIG. 1.

FIG. 4 is a perspective view of the back-face side of a cover member of the flow sensing device illustrated in FIG. 1.

FIG. 5 illustrates the back face of a driving board disposed in the flow sensing device according to the present embodiment.

FIG. 6 illustrates the back face of a sensing board disposed in the flow sensing device according to the present embodiment.

FIG. 7 is a circuit diagram (exemplary circuit diagram) of the flow sensing device according to the present embodiment.

FIG. 8 is a front view of a plurality of flow sensing devices connected in series, each being the same as the flow sensing device illustrated in FIG. 1.

FIG. 9 is a front view of a flow sensing device according to another embodiment different from that in FIG. 1.

FIG. 10A is a schematic view of the direction of output of light of the flow sensing device according to the present embodiment.

FIG. 10B is a schematic view of the direction of output of light of the flow sensing device according to the present embodiment.

FIG. 10C is a schematic view of the direction of output of light of the flow sensing device according to the present embodiment.

### DESCRIPTION OF EMBODIMENTS

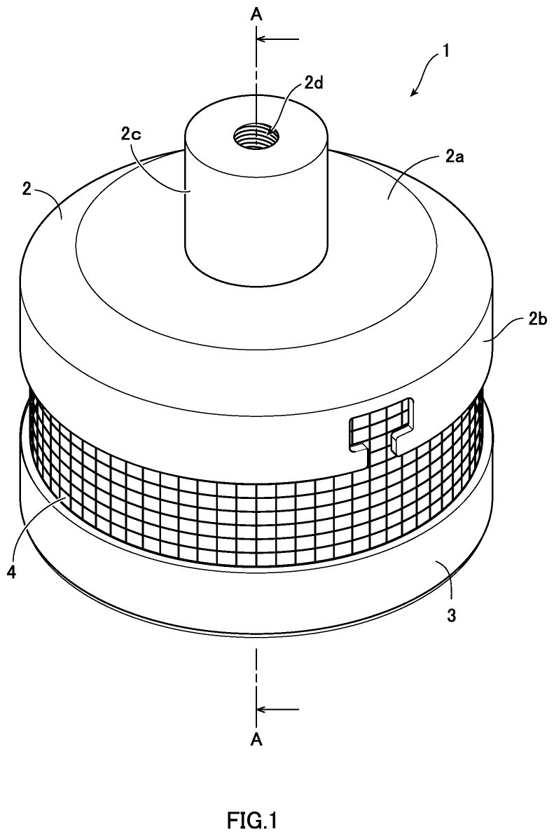

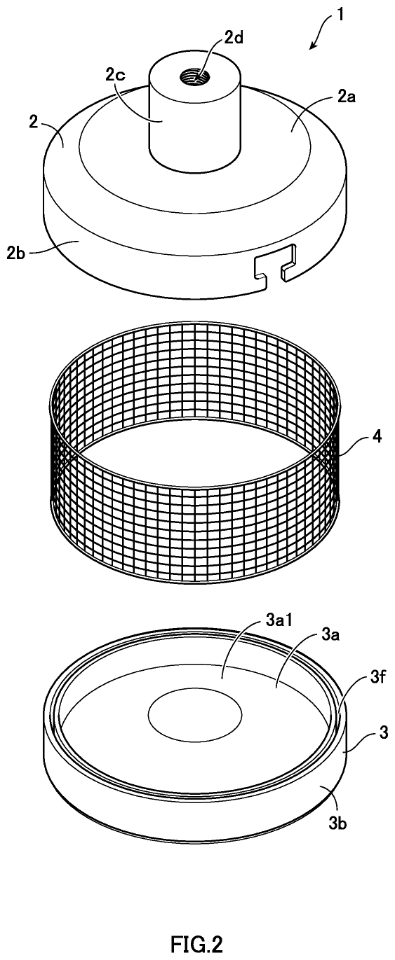

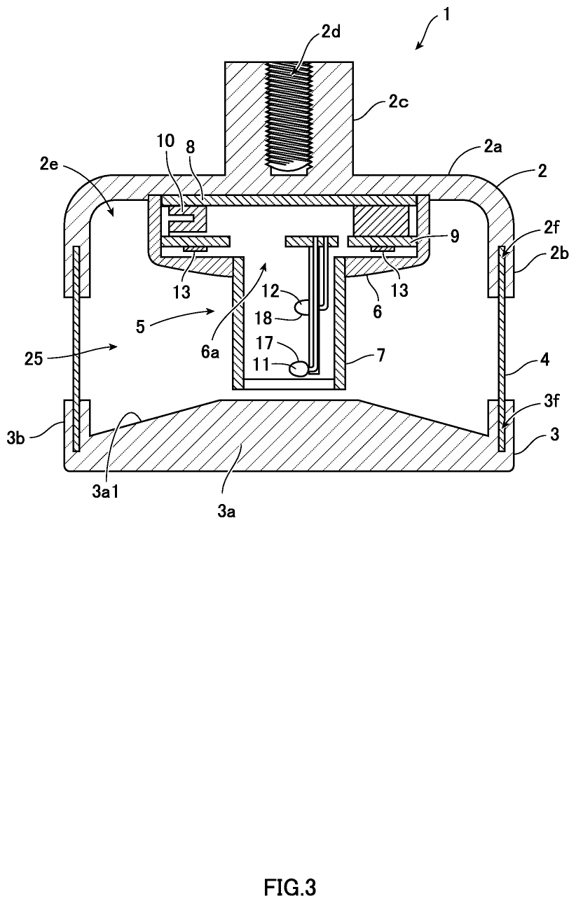

A flow sensing device according to the present embodiment will be described below with reference to the accompanying drawings. FIG. 1 is a perspective view of the flow sensing device according to the present embodiment. FIG. 2 is an exploded perspective view of the flow sensing device illustrated in FIG. 1. FIG. 3 is a sectional view of the flow sensing device illustrated in FIG. 1. The sectional view of FIG. 3 corresponds to a section, viewed in the direction indicated by arrows, due to cutting along line A-A of FIG. 1. Note that, in the present embodiment, although a flow sensor will be exemplarily given as a sensing device, any detection target, of which the flow rate varying can be detected by the sensing device, may be provided. Note that, in the following description, sensing elements 11 and 12 will be each given as a wind-velocity sensor.

The flow sensing device 1 illustrated in FIGS. 1 to 3 includes a cover member 2, a cap member 3, and a foreign-body intrusion prevention net 4 located between the cover member 2 and the cap member 3.

As illustrated in FIGS. 1 to 3, the cover member 2 is located at the upper portion of the flow sensing device 1, the cap member 3 is located at the lower portion of the flow sensing device 1, and the foreign-body intrusion prevention net 4 is located at the intermediate portion of the flow sensing device 1. The cover member 2 will be first described.

<Cover Member 2>

The cover member 2 functions as a waterproof cover that protects a board unit 5 disposed inside the flow sensing device 1, for example, against rain or snow. Thus, the flow sensing device 1 according to the present embodiment can be applied outdoors.

As illustrated in FIGS. 1 to 3, the cover member 2 includes a ceiling portion 2a, a side wall portion 2b protruding downward from the outer circumference of the ceiling portion 2a, and a hanging portion 2c that is columnar in shape and is provided at the central upper face of the ceiling portion 2a. The ceiling portion 2a, the side wall portion 2b, and the hanging portion 2c are integrally formed together. In the present embodiment, the ceiling portion 2a is circular in shape, but this is not limiting.

As illustrated in FIGS. 1 to 3, the hanging portion 2c has a connection hole 2d at its center, and the connection hole 2d has a threaded inner wall face.

As illustrated in FIG. 3, the side wall portion 2b has, in the circumferential direction on its lower face, a groove 2f having a width enabling insertion of the foreign-body intrusion prevention net 4.

Examples of the material of the cover member 2 include, but not limited to, thermoplastic resin, such as acrylic resin and polycarbonate resin, and glass. The cover member 2 is waterproof. The cover member 2 may be transparent, translucent, or opaque. “Translucency” indicates a state lower in transmissivity than transparency.

As illustrated in FIG. 3, a driving board 8, a sensing board 9, and a lid 6 included in the board unit 5 are housed in a housing room 2e between the ceiling portion 2a and the side wall portion 2b of the cover member 2. The board unit 5 disposed on the back-face side of the cover member 2 will be described below.

<Board Unit 5>

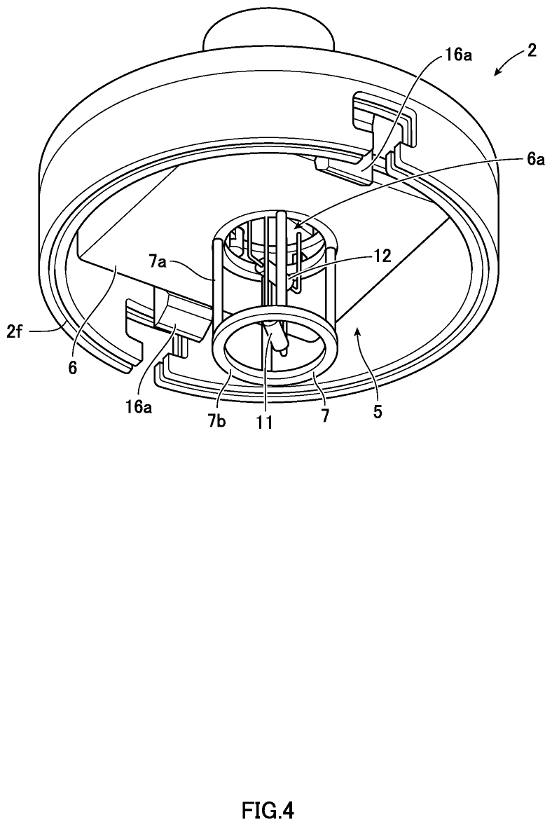

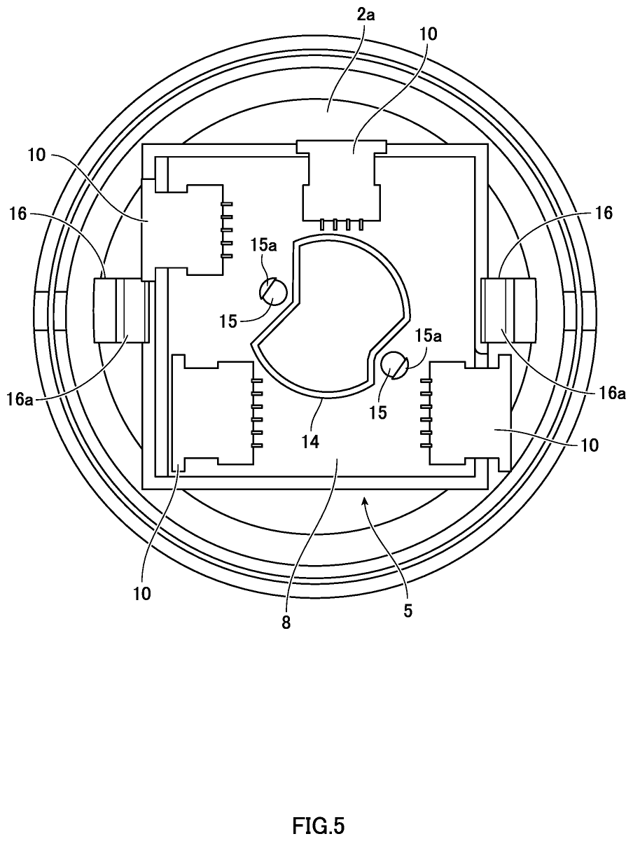

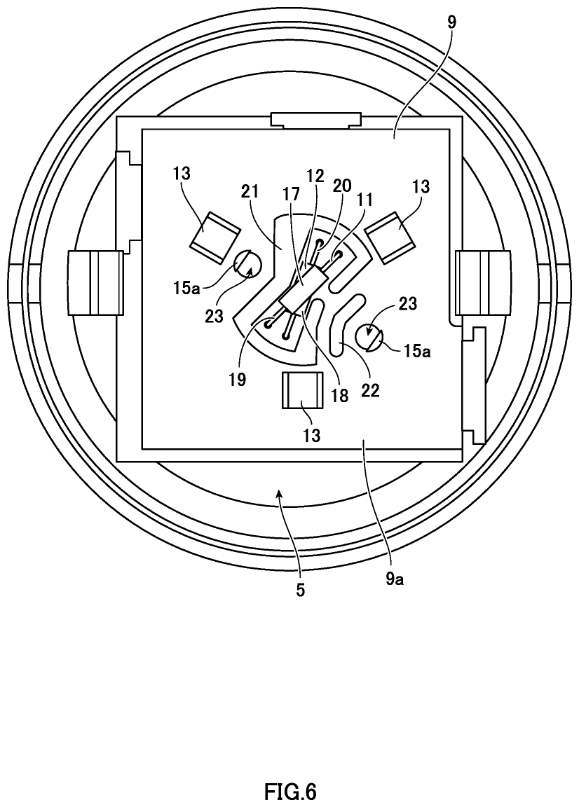

FIG. 4 is a perspective view of the back-face side of the cover member of the flow sensing device illustrated in FIG. 1. FIG. 5 illustrates the back face of the driving board disposed in the flow sensing device according to the present embodiment. FIG. 6 illustrates the back face of the sensing board disposed in the flow sensing device according to the present embodiment.

As illustrated in FIG. 4, when the board unit 5 is viewed from the back-face side, the lid 6 covering, from below, the driving board 8 to be described next and the sensing board 9, the sensing elements 11 and 12 protruding downward from an opening 6a at the center of the lid 6, and a guard member 7 are present.

(Driving Board 8)

As illustrated in FIGS. 3 and 5, the driving board 8 is fixed to the back-face side (lower-face side) of the ceiling portion 2a. As illustrated in FIG. 5, the driving board 8 has a surface (lower face) 8a on which various types of connectors 10 and various circuit elements, such as an active element, a passive element, and a functional element, not illustrated, are mounted. Note that the driving board 8 may be integrally formed with the ceiling portion 2a. In that case, the ceiling portion 2a has, for example, the connectors 10 mounted directly on its lower face.

Examples of types of connectors 10 include, but not limited to, a connector for connecting to a power source, a connector for connecting to the higher side, and a connector for connecting to the lower side. In the present embodiment, as described below, a plurality of flow sensing devices 1 can be connected in series. In this case, electrical connection between connectors 10 of the flow sensing devices 1 enables transmission and reception of signals between the flow sensing devices 1.

As illustrated in FIG. 5, an almost center of the driving board 8 is provided with a protruding hollow support 14. When the sensing board 9 to be described next is disposed on the lower-face side of the driving board 8, the support 14 retains a predetermined interval between the sensing board 9 and the driving board 8. The support 14 and the sensing board 9 may be in contact or may be out of contact. As illustrated in FIG. 5, a plurality of first couplers 15 protrudes downward from the region outside the support 14. The first couplers 15 each have a leading end portion having a hook portion 15a. The first couplers 15 are inserted into connection holes 23 that the sensing board 9 has, so that the hook portions 15a can each fasten with the edge portion of the corresponding hole (refer to FIG. 6). Thus, the sensing board 9 can be fixed to the lower-face side of the driving board 8.

As illustrated in FIG. 5, outside the driving board 8, a plurality of second couplers 16 protrudes downward from the lower face of the ceiling portion 2a. The second couplers 16 each have a leading end portion having a hook portion 16a. As illustrated in FIG. 4, the hook portions 16a can fasten with the outer edge of the lid 6. Thus, the lid 6 can be fixed to the lower-face side of the ceiling portion 2a.

(Sensing Board 9)

As described above, the sensing board 9 illustrated in FIG. 6 is disposed in superimposition on the lower-face side of the driving board 8 illustrated in FIG. 5. In this case, with the driving board 8 having the first couplers 15 inserted through the connection holes 23 that the sensing board 9 has, the hook portions 15a abut on the circumferential edges of the connection holes 23, so that the sensing board 9 is retained on the lower-face side of the driving board 8.

As illustrated in FIG. 6, the sensing board 9 has a surface (lower face) 9a on which the sensing elements 11 and 12 and LEDs 13 are mounted.

The sensing element 11 includes a resistive element for flow detection 17 to be described below and is connected to lead terminals (lead wires) 19. The sensing element 12 includes a resistive element for temperature compensation 18 to be described below and is connected to lead terminals (lead wires) 20.

The lead terminals 19 located on both sides of the resistive element for flow detection 17 and the lead terminals 20 located on both sides of the resistive element for temperature compensation 18 bend and are fixed in connection with the surface 9a of the sensing board 9. For example, the sensing board 9 has terminal holes (not illustrated), and the respective leading ends of the lead terminals 19 and 20 are inserted in the terminal holes. Then, the lead terminals 19 and 20 are fixed to the sensing board 9, for example, with solder. Thus, the sensing elements 11 and 12 are each in electrical connection with a driving control circuit provided on the driving board 8.

As illustrated in FIGS. 3 and 4, the sensing elements 11 and 12 are supported in hanging from the side on which the ceiling portion 2a of the cover member 2 is located.

As illustrated in FIG. 6, the sensing board 9 has a first groove 21 so as to surround almost the sensing elements 11 and 12. A second groove 22 is formed near the location at which the first groove 21 has a disconnection. As above, the grooves 21 and 22 provided so as to surround the sensing elements 11 and 12 enable separation between the heat source of the sensing board 9 and the heat source of the driving board 8, so that thermal influence can be weakened on the sensing elements 11 and 12.

As illustrated in FIG. 3 or 6, the surface 9a of the sensing board 9 is provided with a plurality of LEDs 13. The LEDs 13 each serve as a light emitting element that performs downward surface emission. Referring to FIG. 6, the number of LEDs 13 is, but not limited to, three. Note that, in the present embodiment, an LED 13 is provided as an exemplary light emitting element, but a light emitting element different from such an LED 13 may be applied.

Preferably, the plurality of LEDs 13 is disposed at regular intervals (at regular angles) about the board center. Note that the arrangement of the LEDs 13 can be appropriately changed depending on the purpose of use.

(Sensing Elements 11 and 12)

The sensing elements 11 and 12 will be described. For example, the sensing element 11 includes the resistive element for flow detection 17 as a thermosensitive resistive element. The sensing element 12 includes the resistive element for temperature compensation 18 as a thermosensitive resistive element.

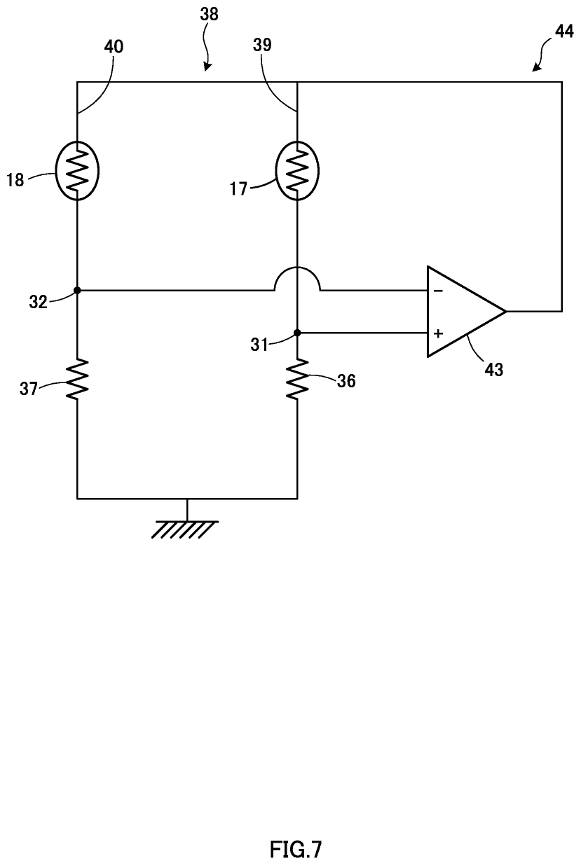

The resistive element for flow detection 17 and the resistive element for temperature compensation 18 are included in a circuit illustrated in FIG. 7. As illustrated in FIG. 7, the resistive element for flow detection 17, the resistive element for temperature compensation 18, and resistors 36 and 37 achieve a bridge circuit 38. As illustrated in FIG. 7, the resistive element for flow detection 17 and the resistor 36 achieve a first series circuit 39, and the resistive element for temperature compensation 18 and the resistor 37 achieve a second series circuit 40. Then, the first series circuit 39 and the second series circuit 40 are connected in parallel, achieving the bridge circuit 38.

As illustrated in FIG. 7, an output 31 of the first series circuit 39 and an output 32 of the second series circuit 40 are each connected to a differential amplifier (amp) 43. A feedback circuit 44 including the differential amplifier 43 is connected to the bridge circuit 38. For example, the feedback circuit 44 includes a transistor (not illustrated).

The resistors 36 and 37 are smaller in temperature coefficient of resistance (TCR) than the resistive element for flow detection 17 and the resistive element for temperature compensation 18. For example, the resistive element for flow detection 17 in heating controlled so as to be higher by a predetermined value than a predetermined ambient temperature, has a predetermined resistance value Rs1. For example, the resistive element for temperature compensation 18 is controlled so as to have a predetermined resistance value Rs2 at the ambient temperature. Note that the resistance value Rsl is smaller than the resistance value Rs2. For example, the resistor 36 that achieves the first series circuit 39 together with the resistive element for flow detection 17 serves as a fixed resistor having a resistance value R1 similar to the resistance value Rs1 of the resistive element for flow detection 17. The resistor 37 that achieves the second series circuit 40 together with the resistive element for temperature compensation 18 serves as a fixed resistor having a resistance value R2 similar to the resistance value Rs2 of the resistive element for temperature compensation 18.

Because of the sensing element 11 set at the temperature higher than the ambient temperature, in response to reception of wind, the temperature of the resistive element for flow detection 17 as a heating resistor drops. Thus, the potential varies at the output 31 of the first series circuit 39 having the resistive element for flow detection 17 connected therein. Thus, a differential output is acquired by the differential amplifier 43. Then, on the basis of the differential output, a driving voltage is applied to the resistive element for flow detection 17 through the feedback circuit 44. Then, on the basis of a variation in voltage required for heating of the resistive element for flow detection 17, a microcomputer (not illustrated) performs conversion to wind velocity, so that the wind velocity can be output. Note that, for example, the microcomputer, the resistors, and the transistor are installed on the surface of the driving board 8 and are in electrical connection with the sensing elements 11 and 12 through the lead terminals 19 and 20.

The resistive element for temperature compensation 18 provided in the sensing element 12 detects the temperature of fluid itself and compensates the influence of a variation in the temperature of fluid. The resistive element for temperature compensation 18 provided as above enables reduction of the influence of a variation in the temperature of fluid on flow detection, resulting in achievement of accurate flow detection. As described above, the resistive element for temperature compensation 18 is sufficiently higher in resistance than the resistive element for flow detection 17 and has its temperature set close to the ambient temperature. Thus, even when the sensing element 12 receives wind, the potential hardly varies at the output 32 of the second series circuit 40 having the resistive element for temperature compensation 18 connected therein. Therefore, with the potential at the output 32 as the standard potential, the differential output based on a variation in the resistance of the resistive element for flow detection 17 can be acquired accurately.

Note that the configuration of the circuit illustrated in FIG. 7 is exemplary, and thus this is not limiting.

As illustrated in FIG. 3 or 6, the sensing elements 11 and 12 are disposed in a housing space 25 surrounded by the cover member 2, the cap member 3, and the foreign-body intrusion prevention net 4. In addition, the LEDs 13 are disposed in the housing space 25 (particularly, in the housing room 2e of the cover member 2).

As illustrated in FIG. 3, the sensing element 11 having the resistive element for flow detection 17 connected therein is disposed inside the foreign-body intrusion prevention net 4, so as to receive wind properly through the foreign-body intrusion prevention net 4. As illustrated in FIG. 3, the sensing element 11 having the resistive element for flow detection 17 connected therein is located below the sensing element 12 having the resistive element for temperature compensation 18 connected therein. Meanwhile, the sensing element 12 having the resistive element for temperature compensation 18 connected therein is provided near the lid 6, namely, receives wind through the foreign-body intrusion prevention net 4 less easily than the resistive element for flow detection 17 does. As in the present embodiment, such a difference in height between the resistive element for flow detection 17 and the resistive element for temperature compensation 18 enables the resistive element for flow detection 17 to receive wind properly.

Note that the arrangement of the sensing elements 11 and 12 illustrated in FIG. 3 or 6 is exemplary, and thus the sensing elements 11 and 12 may be arranged side by side with an interval laterally. For the sensing elements 11 and 12, chip resistive elements can be used.

(Lid 6)

The lid 6 is disposed in superimposition on the lower-face side of the sensing board 9 illustrated in FIG. 6. In this case, as illustrated in FIG. 4, the respective hook portions 16a of the second couplers 16 disposed on the lower face of the ceiling portion 2a fasten with the outer edge of the lid 6, so that the lid 6 is fixed on the lower-face side of the sensing board 9.

As illustrated in FIGS. 3 and 4, the lid 6 has the opening 6a at its center. Therefore, when the lid 6 is fixed on the lower-face side of the sensing board 9, the sensing elements 11 and 12 are supported protruding downward from the lid 6 through the opening 6a.

As illustrated in FIG. 4, the guard member 7 is fixed in connection with the outer circumference of the opening 6a of the lid 6. For example, the guard member 7 includes a plurality of pillar members 7a disposed at almost regular intervals along the outer circumference of the opening 6a, and a ring portion 7b disposed on the respective leading ends of the pillar members 7a. Preferably, the pillar members 7a and the ring portion 7b are integrally formed together. The sensing elements 11 and 12 are disposed inside the guard member 7. Thus, at the time of assembly of each part of the flow sensing device 1, troubles can be inhibited, such as damage of the sensing elements 11 and 12 and deterioration in the sensitivity of the sensing elements 11 and 12 due to a touch on the sensing elements 11 and 12 by fingers. The space between each pillar member 7a serves as a passage for wind, enabling proper measurement of wind velocity with the sensing elements 11 and 12.

Preferably, the lid 6 is a transparent member or a translucent member, so that light from each LED 13 can be guided downward through the lid 6. Note that provided can be a mode in which light is output outward through the surface of the cover member 2 without passing downward, namely, a mode in which light is guided from laterally to upward. In this case, the lid 6 may be an opaque member, but preferably the inner face of the lid 6 (namely, the upper face facing each LED 13) is a light reflective face or a light diffusing face.

<Cap Member 3>

As illustrated in FIGS. 2 and 3, the cap member 3 includes a bottom portion 3a and a side wall portion 3b formed on the outer circumference of the bottom portion 3a. The outer circumference of the bottom portion 3a is circular and is identical in shape and size to the outer circumference of the ceiling portion 2a of the cover member 2, but this is not limiting.

As illustrated in FIGS. 2 and 3, the surface (upper face) of the bottom portion 3a is shaped like a truncated cone (frustum). The inclined face 3a1 of the truncated cone functions as a light diffusing face (light reflective face) that reflects and diffuses light in all directions.

As illustrated in FIGS. 2 and 3, the side wall portion 3b has, in the circumferential direction on its upper face, a groove 3f having a width enabling insertion of the foreign-body intrusion prevention net 4.

The cap member 3 is not limited in material, and thus the cap member 3 may be transparent, translucent, or opaque. In particular, in order to cause the inclined face 3a1 of the truncated cone to function as a light diffusing face as described above, the cap member 3 may be colored and opaque.

Note that, for a mode in which the cap member 3 is transmissive and light from the LEDs 13 is output downward through the lower face of the cap member 3, preferably, for example, the cap member 3 is a transparent member formed of thermoplastic resin, such as acrylic resin or polycarbonate resin, or glass.

<Foreign-Body Intrusion Prevention Net 4>

The upper portion and the lower portion of the foreign-body intrusion prevention net 4 are inserted, respectively, into the grooves 2f and 3f of the side wall portions 2b and 3b of the cover member 2 and the cap member 3. Thus, the foreign-body intrusion prevention net 4 is fixed between the cover member 2 and the cap member 3.

Preferably, the foreign-body intrusion prevention net 4 is a meshed member having meshes as a plurality of through holes. The foreign-body intrusion prevention net 4 is not limited in material but is preferably formed of meshed nonwoven fabric or resin material.

The flow sensing device 1 according to the present embodiment can protect, due to the cover member 2, the board unit 5, for example, against rain or snow. In addition, the foreign-body intrusion prevention net 4 allows wind to pass through while preventing, for example, insects from intruding inside, so that particularly the sensing elements 11 and 12 having been exposed and supported, included in the board unit 5 can be protected against intrusion of foreign bodies, such as insects.

As above, the structure of the flow sensing device 1 according to the present embodiment enables enhancements in weather resistance and insect resistance.

<Series Structure of Flow Sensing Devices>

The flow sensing device 1 illustrated in FIG. 1 includes the hanging portion 2c on the upper face of the cover member 2, so that the flow sensing device 1 can be supported in hanging.

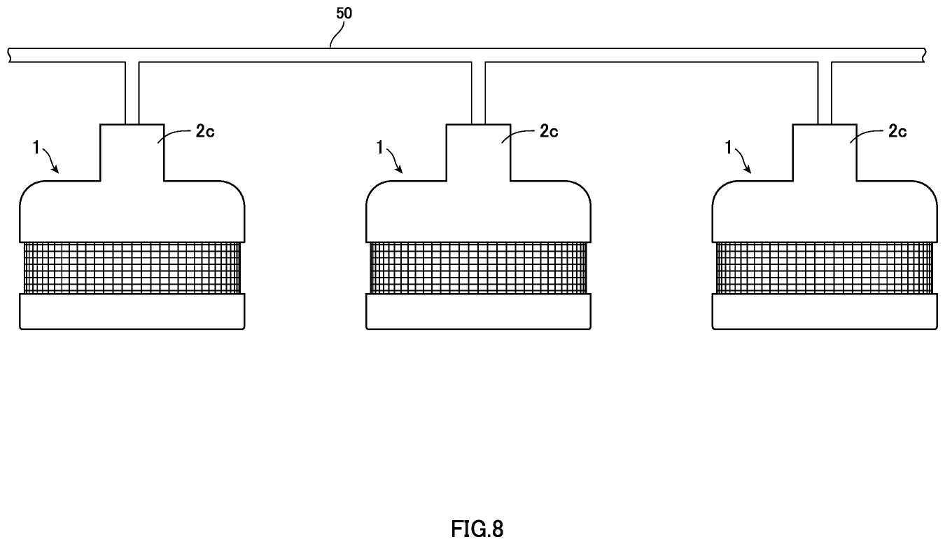

Therefore, for example, as illustrated in FIG. 8, provided can be a series structure in which a plurality of flow sensing devices 1 is hung by screw fixation on a support 50 shaped like a bar. In this case, the plurality of flow sensing devices 1 connected in series may be each identical or different in structure.

The plurality of flow sensing devices 1 connected in series enables, for example, various types of illumination performance.

<Flow Sensing Device according to Another Embodiment>

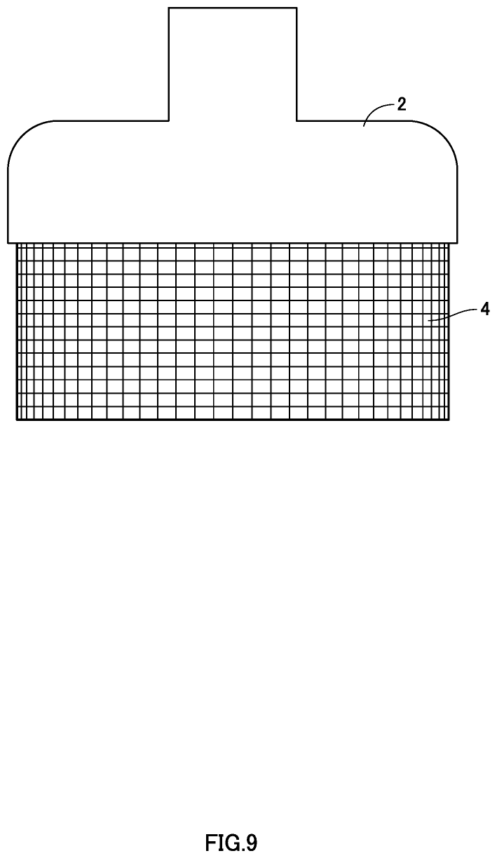

The flow sensing device 1 illustrated in FIG. 1 includes the cover member 2, the cap member 3, and the foreign-body intrusion prevention net 4 located between the cover member 2 and the cap member 3. However, as illustrated in FIG. 9, the lower side of a cover member 2 may be covered with a foreign-body intrusion prevention net 4 with no cap member 3. That is, according to the structure of a flow sensing device illustrated in FIG. 9, a foreign-body intrusion prevention net 4 shaped like a case is disposed on the lower side of a cover member 2, so that the foreign-body intrusion prevention net 4 prevents foreign bodies, such as insects, from intruding through its side face or lower face. The structure of the flow sensing device illustrated in FIG. 9 is less in the number of components than that illustrated in FIG. 1, leading to a simple structure.

<Light Emission with LEDs>

The flow sensing device 1 according to the present embodiment has the LEDs 13 built in, in which light from the LEDs 13 can be emitted outside the flow sensing device 1. In this case, on the basis of measurement results of wind velocity from the sensing elements 11 and 12, the LEDs 13 can emit light.

For example, the series structure of the flow sensing devices 1 illustrated in FIG. 8 enables sequential light emission of the LEDs 13 in each flow sensing device 1, based on measurement results of wind. Note that a mode of light emission can be appropriately set. Thus, visualization of a flow of air can be achieved.

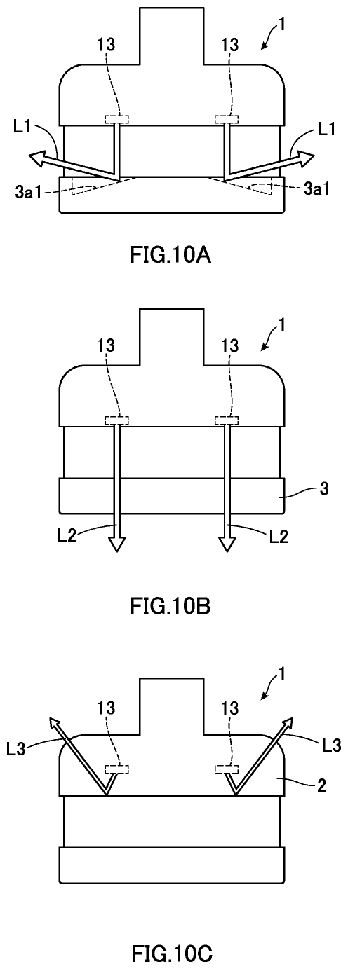

As illustrated in FIG. 3, the cap member 3 is provided with the inclined face 3a1 as a light diffusing face. As illustrated in FIG. 10A, light L1 emitted downward from each LED 13 is reflected off the inclined face 3a1, so that the light L1 can be output outward through the circumference of the flow sensing device 1. Referring to FIG. 10A, mainly, the side face of the flow sensing device 1 illuminates.

Alternatively, as illustrated in FIG. 10B, light L2 emitted downward from each LED 13 can be directly output downward through the cap member 3. Referring to FIG. 10B, mainly, the lower face of the flow sensing device 1 illuminates. Referring to FIG. 10B, preferably, with the cap member 3 transparent, provided is a structure enabling inhibition of light reflection inside the cap member 3.

As illustrated in FIG. 10C, for example, light L3 of each LED 13 can be output upward through the cover member 2 after reflection inside the cover member 2.

Due to a plurality of combinations of the directions of emission of light illustrated in FIGS. 10A to 10C, for example, provided can be a structure enabling illumination ranging from the side face to the lower face of the flow sensing device 1, a structure enabling illumination ranging from the side face to the upper face of the flow sensing device 1, and a structure enabling illumination of the entirety of the flow sensing device 1.

The flow sensing device 1 according to the present embodiment excels in weather resistance and insect resistance and thus is suitable for outdoor use. Needless to say, the flow sensing device 1 according to the present embodiment can be used indoors. For example, the flow sensing device 1 can be applied to light performance, such as illumination, or an analyzing device.

The sensing elements 11 and 12 described above each serve as a wind-velocity sensor, but may serve as a sensor capable of detecting a variation in the flow velocity of a target that is a flow of gas or liquid, such as water, instead of wind velocity.

### INDUSTRIAL APPLICABILITY

As described above, the present invention enables arrangement of a sensing element and a light emitting element, and moreover, various applications as display modes and applications for analysis, with flow detection, regardless of indoor or outdoor use.

This application is based on Japanese Patent Application No. 2019-166533, filed Sep. 12, 2019. The entire contents thereof are incorporated herein by reference.

1. A flow sensing device comprising:
a cover member;
a cap member disposed below the cover member;
a foreign-body intrusion prevention net surrounding a space between the cover member and the cap member;
a light emitting element disposed in a housing space surrounded by the cover member, the cap member, and the foreign-body intrusion prevention net; and
a sensing element disposed inside the foreign-body intrusion prevention net in the housing space, the sensing element including a thermosensitive resistive element.

2. The flow sensing device according to claim 1, wherein the cap member has an inner face serving as a light diffusing face or a light reflective face.

3. The flow sensing device according to claim 1, wherein, instead of the cap member, the foreign-body intrusion prevention net covers a lower side of the cover member.

4. The flow sensing device according to claim 1, wherein the cover member includes a hanging portion enabling support in hanging.

5. The flow sensing device according to claim 4, wherein a plurality of the flow sensing devices is connected in series through the hanging portion of each of the plurality of the flow sensing devices.

6. The flow sensing device according to claim 5, wherein the light emitting element is disposed on a board, and the board is disposed in the housing space such that the light emitting element faces downward.

7. The flow sensing device according to claim 1, wherein the sensing element is supported through a lead wire in hanging from a side on which a ceiling portion of the cover member is located.
